(19) United States
(12) Patent Application Publication
(10) Pub. No.: US 2013/0214633 A1
(43) Pub. Date: Aug. 22, 2013

(54) ELECTRIC MACHINE AND STATOR FOR SAME

(71) Applicant: Gurakuq Dajaku, Neubiberg (DE)

(72) Inventor: Gurakuq Dajaku, Neubiberg (DE)

(73) Assignee: FEAAM GmbH, Neubiberg (DE)

(21) Appl. No.: 13/812,862

(22) PCT Filed: Jul. 29, 2011
(86) PCT No.: PCT/EP2011/063108

§ 371 Date: Apr. 4, 2013

(30) Foreign Application Priority Data
Jul. 29, 2010 (DE) 102010032764.6

(51) Int. Cl. H02K 3/46

(52) U.S. Cl. CPC H02K 3/46
USPC 310/180

(57) ABSTRACT

The invention relates to a stator for an electric machine, comprising at least two sub-stators having respective grooves for receiving windings. The groove openings of the two sub-stators are displaced in relation to each other in the circumferential direction. The invention further relates to an electric machine comprising the stator. The two sub-stators are combined with each other axially and/or in the circumferential direction.

The present invention pertains to a stator for an electric machine, as well as an electric machine with a stator and a rotor.

Electric machines comprise a stationary stator and a rotor that is movable relative thereto. The stator contains grooves, into which electric windings can be placed. Electric machines of this type frequently feature one or more permanent magnets with one respective north pole and south pole. This generates a cogging torque of the machine that depends on the machine geometry. The cogging torque leads to undesirable noises and mechanical vibrations. Furthermore, the energy utilization and the efficiency of the machine are reduced.

In addition, the cogging torque and the associated torque ripple cause speed fluctuations and control problems.

The cogging torque is ultimately caused by the interaction, namely, the magnetic attraction between the magnetic flux of the magnets and the stator geometry, leading to a variable reluctance with angular dependence of the rotor. The torque ripple is the result of the interaction between higher harmonics of the flux density in the air gap that are caused by the rotor magnets and stator currents. In salient-pole rotor topologies, additional torque ripple components occur as a result of an interaction between the magnetic flux of stator currents and higher harmonics of the magnetic conductance of the rotor.

In industrial applications, there is a demand for modern motors with low torque ripple and low cogging torque. The torque ripple and the cogging torque should, for example, respectively be lower than 5% and 0.5% of the nominal torque.

In the article “Cogging Torque Reduction in a Permanent Magnet Wind Turbine Generator,” E. Muljadi and J. Green, 21. American Society of Mechanical Engineers, Wind Energy Symposium, Reno, Nevada, Jan. 14 to 17, 2002, NREL/CP-500-30768, it is proposed to reduce the cogging torque in a wind turbine. For this purpose, a uniform air gap, a manipulation of the pole width and a tilt of the rotor are taken into consideration.

In these approaches, however, it is disadvantageous that the efficiency is reduced and/or the manufacturing costs are increased.

It is the objective of the present invention to disclose an electric machine and a rotor for an electric machine, by means of which a lower cogging torque and a reduced torque ripple can be achieved with high efficiency and low manufacturing costs.

This objective is attained with the characteristics of the independent claims. Enhancements and embodiments form the objects of the dependent claims.

According to an embodiment, a stator for an electric machine comprises at least two sub-stators. The sub-stators jointly form the stator for the electric machine. Each sub-stator comprises grooves for receiving windings. The grooves have groove openings. The groove openings of the grooves of the at least one second sub-stator are circumferentially shifted relative to the position of the groove openings of the grooves of the first sub-stator. The two sub-stators are combined with one another axially and/or in the circumferential direction.

The groove openings are preferably aligned toward the air gap of the electric machine.

For example, a symmetry axis of the groove openings of the grooves of the first sub-stator is shifted relative to the symmetry axis of the grooves by a first angle in one direction while the symmetry axes of the groove openings of the at least one second sub-stator are oppositely shifted relative to its symmetry axes of the grooves by the same or a different angle in the opposite direction.

A shift of the groove openings leads to a corresponding shift of the cogging torque curve by a certain angle. The division of the stator into several sub-stators allows a configuration in which the cogging torque curves of sub-stators with differently positioned groove openings just cancel one another out. In other words, a suitable relative shift between the groove openings of the sub-stators makes it possible to achieve an infinitesimal cogging torque of the overall stator for an electric machine. This is the case, for example, when the cogging torque curves of the sub-stators are shifted relative to one another by 180° and the curves therefore completely cancel one another out.

In contrast to a tilted rotor, the proposed principle with at least two sub-stators, into which the stator is divided either axially or in the circumferential direction, as well as a shift of the groove openings, can also be realized with relatively little effort in series production. A cost-efficient realization therefore is achieved. The efficiency of the machine, as well as other performance parameters, remains basically unchanged.

According to an enhancement, the groove openings of the grooves of the at least one second sub-stator are shifted relative to the groove openings of the grooves of the first sub-stator in the axial direction or in the circumferential direction in such a way that the cogging torque of the sub-stators is mutually compensated and/or the torque ripple is reduced.

Except for the shift of the groove openings, the sub-stators, into which the stator of the electric machine is divided, have the same design and, in particular, the same geometry according to an enhancement.

In particular, the teeth formed between adjacent grooves may have the same pole shape and pole width and differ merely with respect to the position of the groove openings assigned to different sub-stators.

According to the proposed principle, an axial compensation of the cogging torques is realized. For this purpose, additionally deepened grooves may be provided in one of the sub-stators.

If the stator is divided in the circumferential direction, for example, a rightward shift of the groove openings may be realized in a sub-stator along the circumference in a cross-sectionally semicircular segment of the stator and a leftward shift of the groove openings by the same angle may be realized in the opposite half segment, i.e., in the other sub-stator.

According to another embodiment, an electric machine comprising a stator of the above-described type is proposed. A rotor is provided and supported such that it is rotatable relative to the stator. The rotor may be realized analogous to a conventional machine and comprise, for example, permanent magnets.

Alternatively to a rotationally symmetrical machine, the proposed principle can also be applied in a linear machine, i.e., a linear motor or linear generator. In this case, the rotor is realized such that it is movable along the stator.

In a linear machine, the groove openings are not shifted by a certain angle, but rather shifted from a symmetry axis or center position by a certain length in the moving direction of the rotor.

The electric machine consists, for example, of one of the following types: linear motor, transverse flux motor, radial flux motor, asynchronous motor, synchronous motor.

Furthermore, the machine may be realized with internal rotor or in the form of a machine with external rotor.

The rotor may be realized in the form of a cage rotor or, in the case of an asynchronous motor, in the form of a multilayer rotor. In the case of a synchronous motor, the rotor may be realized in the form of a permanent magnet rotor, a rotor with buried magnets, an electrically fed rotor, particularly a smooth-core rotor, a salient-pole rotor, a heteropolar rotor or a homopolar rotor.

Several exemplary embodiments of the invention are described in greater detail below with reference to the drawings. In these drawings, identical or identically functioning components are identified by the same reference symbols.

In said drawings:

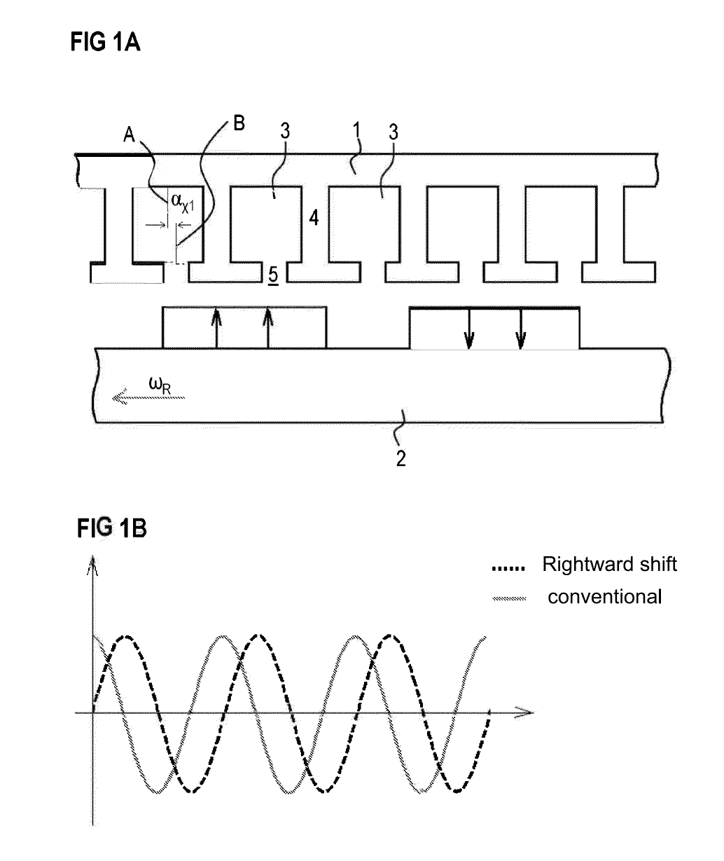

FIG. 1A shows a first exemplary embodiment of a sub-rotor according to the proposed principle in the form of a developed view,

FIG. 1B shows the corresponding cogging torque curve,

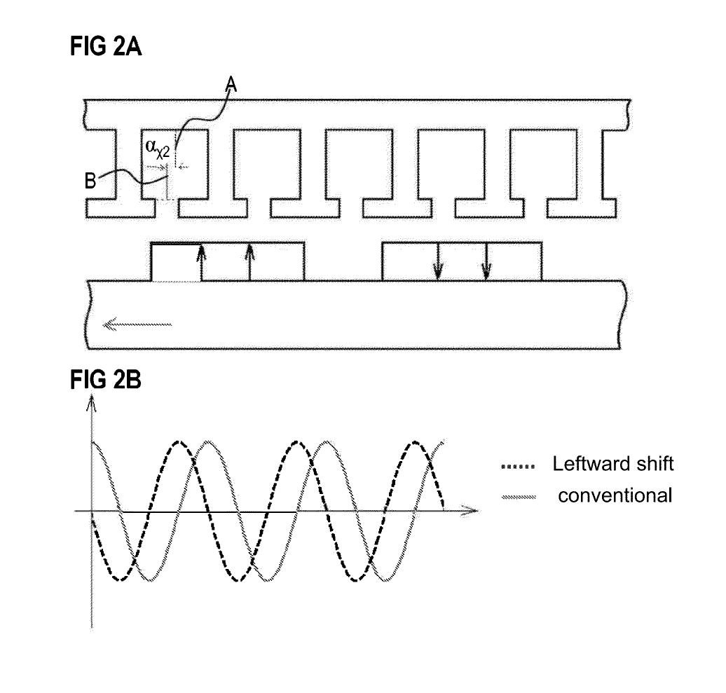

FIG. 2A shows an exemplary second sub-rotor according to the proposed principle,

FIG. 2B shows the corresponding cogging torque curve for FIG. 2A,

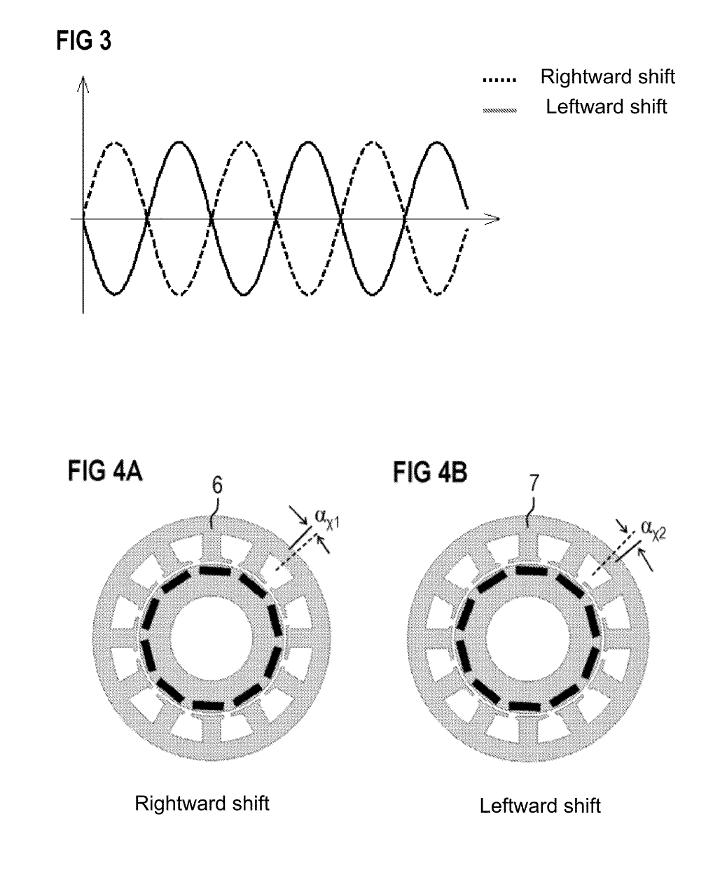

FIG. 3 shows a combination of the cogging torque curves of FIG. 1B and FIG. 2B,

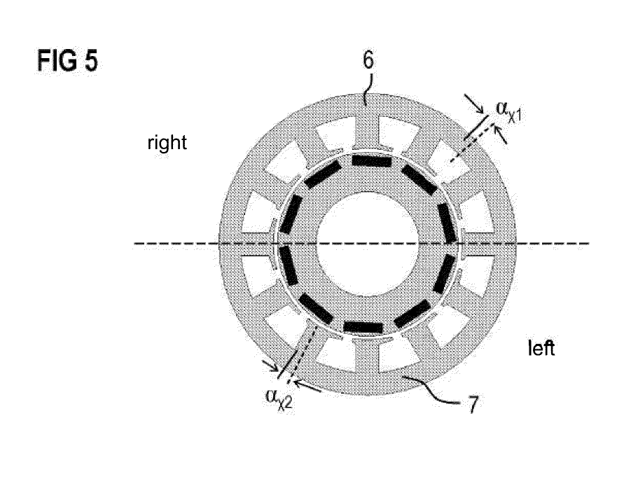

FIG. 4A shows an exemplary embodiment of the proposed principle in an electric machine with a first sub-stator,

FIG. 4B shows the illustration in FIG. 4A, however, with a second sub-stator,

FIG. 5 shows a combination of the embodiments in FIG. 4A and FIG. 4B along the circumferential direction,

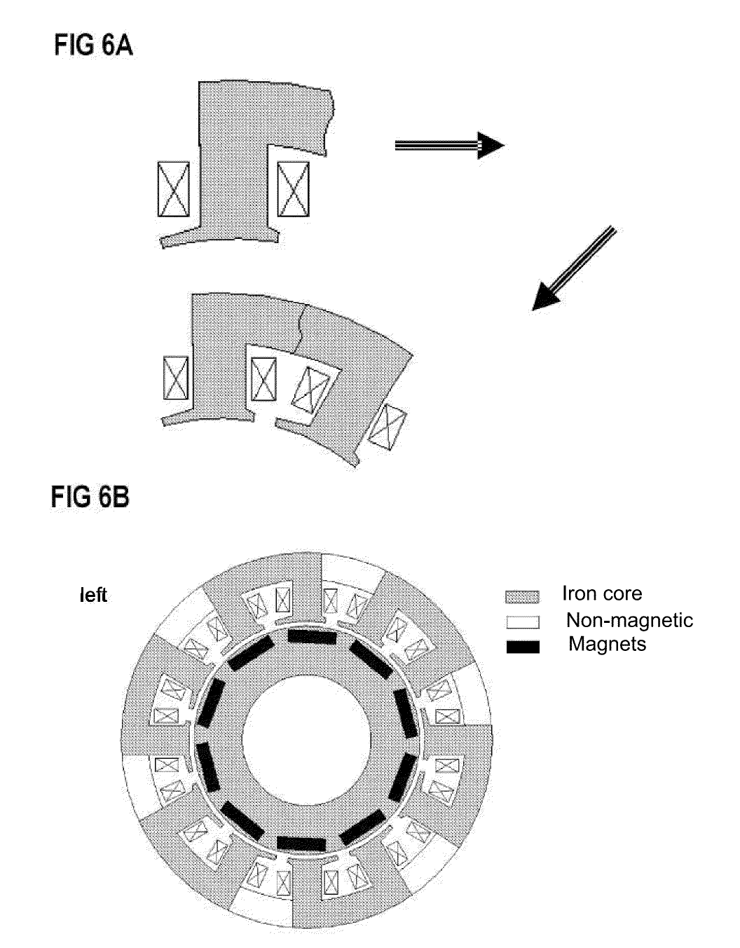

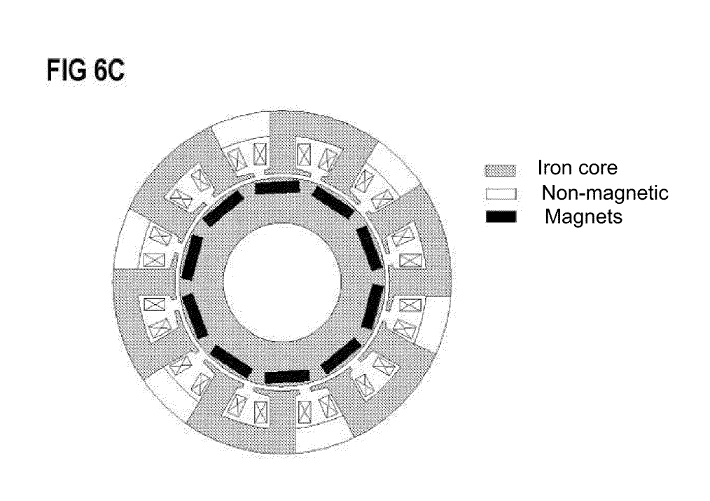

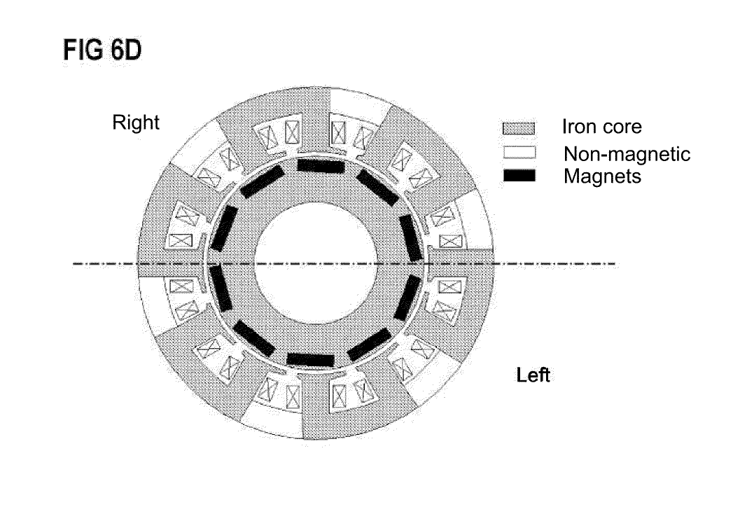

FIG. 6A shows an exemplary embodiment of a stator with a divisible yoke,

FIG. 6B shows an exemplary embodiment of a stator in which the groove openings are shifted to the left,

FIG. 6C shows an exemplary embodiment of a stator in which the groove openings are shifted to the right, and

FIG. 6D shows a combination of two sub-stators according to FIGS. 5B and 5C along the circumferential direction of the stator.

FIG. 1A shows a developed view of a stator 1 and a rotor 2, namely in the form of a respective cross-sectional detail. An air gap is provided between the stator 1 and the rotor 2. The stator 1 features a plurality of adjacently arranged grooves 3, between which teeth 4 are formed. The grooves have a cuboid cross section and respectively feature a groove opening 5. The groove opening 5 is aligned toward the air gap, i.e., toward the rotor. The groove opening has a smaller width than the groove itself such that the groove is tapered toward the air gap. The groove 3 has a symmetry axis A and the groove opening likewise has a symmetry axis B. These bisecting lines are visible in the form of axes in the cross section and actual symmetry planes of the three-dimensionally extending electric machine. The figure shows that all groove openings 5 have a symmetry axis B that is shifted relative to the symmetry axis A of the groove 3 itself by an angle αX1. Due to the developed view, the angle is illustrated in the form of a distance.

In other words, the groove opening is not arranged centrally on the side of the groove that faces the air gap, but rather shifted relative thereto by the angle αX1.

The rotor 2 is arranged essentially parallel to the stator 1 and features north and south poles in the form of permanent magnets, the magnetization of which is indicated with arrows.

The torque curves in FIG. 1B clearly show that a rightward shift of the groove openings also causes the corresponding cogging torque curve to shift toward the right. In a conventional machine, the symmetry axis B of the groove opening and the symmetry axis A of the groove coincide, i.e., the groove opening is not shifted from the center of the groove. The angle in FIG. 1A would be zero in the conventional machine.

This applies analogously to a leftward shift of the groove opening as illustrated in FIG. 2A. In this case, the symmetry axis B of the groove opening 5 is shifted leftward relative to the symmetry axis A, namely by the angle αX2. This applies to all groove openings of the stator according to FIG. 2.

The shifting angles of the groove openings of the grooves in FIGS. 1A and 2A are identical, but oppositely directed. Other than that, the design and the geometry of the sub-stators according to FIGS. 1A and 2A are identical.

According to the corresponding cogging torque curve illustrated in FIG. 2B, the leftward shift of the symmetry axis of the groove openings, and therefore the leftward shift of the groove openings from the center, also leads to a leftward shift of the corresponding cogging torque curve.

For example, if the stators according to FIG. 1A and FIG. 2A are now combined with one another into a single stator structure, namely, in such a way, for example, that half the axial length of the machine corresponds to the stator according to FIG. 1A and the other half corresponds to the stator according to FIG. 2A, then the resulting cogging torque of the complete stator can be reduced to zero. For example, the shifting angles αX1 and αX2 may be chosen identically or differently depending on the motor design.

For a predetermined shifting angle of the groove openings, the cogging torque components for the first and the second part of the rotor of the machine can be electrically shifted relative to one another by 180° as illustrated in FIG. 3. In this case, the resulting cogging torque of the complete stator or the complete machine, respectively, is completely eliminated.

FIGS. 4A and 4B show another exemplary embodiment, in which the respective sub-stators are combined with one another into a complete stator in the axial direction. Over one part of the axial length, the groove openings are shifted rightward as illustrated in FIG. 4A. The groove openings are shifted leftward relative to the groove center over the other part of the axial length of the stator as illustrated in FIG. 4B.

In FIG. 4A, all groove openings are consequently shifted relative to the groove center rightward or, in other words, in the clockwise direction, by the angle αX1, while FIG. 4B shows a leftward shift by the same angle but in the opposite direction. In other words, the groove openings in the FIG. 4B are shifted in the mathematically positive sense, i.e., in the counterclockwise direction.

This type of stator structure is also referred to as stator structure with discrete groove openings. They may be produced with the same laminations in both halves of the machine, i.e., in the first sub-stator and in the second sub-stator.

Alternatively, several or even any desired number of sub-stators may be consecutively combined with one another in the axial direction, but this naturally increases the manufacturing effort. If the limiting process is carried out, it is possible to realize a stator topology with continuously variable groove openings.

In contrast to FIG. 4A and 4B, FIG. 5 does not show a combination of sub-stators in the axial direction, but rather a combination of sub-stators in the circumferential direction. In this case, the basically circular cross section of the stator is divided into two equally large halves, namely an upper half 6 and a lower half 7.

The upper half of FIG. 5 shows a sub-stator 6 with a rightward shift of the groove openings by the angle αX1 analogous to FIG. 4A while the lower half of this figure shows a sub-stator 7 with a leftward shift of the groove openings, i.e., by the angle αX2.

As illustrated in an exemplary fashion in the cross section according to FIG. 5, the stator may generally be realized with a one-piece lamination per lamination plane. Alternatively, two or more laminations could also be provided per lamination plane and combined with one another during the manufacture.

This solution can also be easily manufactured. In this case, the stator core consists of a laminated structure in only the axial direction. In one half of the minimal symmetry of the machine, the groove openings are shifted rightward, while the groove openings are shifted leftward in the second half of the minimum symmetry.

In comparison with the embodiment according to FIGS. 4A and 4B, the embodiment according to FIG. 5 provides the advantage that the groove opening is constant in the axial direction such that the winding of the stator is additionally simplified. It would naturally also be possible to use more than two different discrete groove opening angles, i.e., the stator may consist of more than two sub-stators. If the stator is divided in the circumferential direction as illustrated in an exemplary fashion in FIG. 5, the limiting factor is the minimal symmetry of the machine.

The embodiment according to FIGS. 4A and B, as well as the embodiment according to FIG. 5, is characterized in that the cogging torque and the torque ripple can be significantly reduced with simple means. The manufacturing costs are basically identical to those of a conventional stator structure.

FIGS. 6A to 6D show an exemplary modular construction of a stator according to the proposed principle that results in a particularly advantageous assembly and low manufacturing costs.

With respect to electric machines having concentrated winding topologies, the manufacturing costs of the stator can be reduced if the stator core is modularly constructed by means of separate components as described below. This is elucidated using the example of a machine with twelve teeth and ten poles.

According to FIG. 6A, a single stator component that comprises the tooth and half the yoke is initially constructed. In the next step, a concentrated winding is wound around the stator tooth as also illustrated in the upper half of FIG. 6A. The winding is marked with X in the cross section.

Two stator components that belong together and both of which have the design and the winding illustrated in the upper half of the figure are combined with one another on the yoke side as illustrated in the lower half of FIG. 6A.

The complete stator is manufactured by assembling the stator modules as illustrated in FIG. 6B. The respective pairs of already combined stator components are assembled into the stator by means of other non-magnetic components.

In the example illustrated in FIGS. 6A and 6B, a sub-stator with a leftward shift of the groove openings is produced.

According to FIG. 6C, the modular manufacturing method analogously makes it possible to realize a configuration of the stator with a rightward shift of the groove openings. If the embodiments of the sub-stators according to FIGS. 6B and 6C are combined into a complete stator in the axial direction, an embodiment similar to that of FIGS. 4A and 4B with the advantages described with reference thereto is realized.

According to FIG. 6D, the sub-stators may alternatively also be combined in the circumferential direction analogous to the embodiment according to FIG. 5. More than two different groove opening angles may also be used for shifting the groove openings in the embodiment according to FIG. 6D, wherein this results in a corresponding number of sub-stators. In this case, the limiting factor is the minimal symmetry of the stator of the machine.

The exemplary embodiments elucidate that the proposed principle makes it possible to realize a stator, as well as an electric machine with a stator, that causes a reduction or complete compensation of the cogging torques, can be manufactured with little effort and also has a high efficiency. The proposed stator topology can be used for all types of known electric machines such as, for example, asynchronous motors, permanent magnet (PM) synchronous motors, brushless DC PM motors, switched reluctance motors, synchronous reluctance motors, DC motors, etc. In addition, the utilization for different combinations of rotor pole numbers and stator numbers is possible and sensible.

### LIST OF REFERENCE SYMBOLS

1 Stator
2 Rotor
3 Groove
4 Tooth
5 Groove opening
6 Sub-stator
7 Sub-stator
A Symmetry axis of the groove
B Symmetry axis of the groove opening
αX1 Shifting angle
αX2 Shifting angle

1. A stator for an electric machine, with the stator comprising:
a first sub-stator and at least one second sub-stator that respectively feature grooves for receiving windings,
wherein groove openings of the grooves of the at least one second sub-stator are shifted in the circumferential direction relative to groove openings of the grooves of the first sub-stator and the two sub-stators are combined with one another axially or in the circumferential direction.

2. The stator according to claim 1, wherein the groove openings of the grooves of the at least one second sub-stator are shifted in the circumferential direction relative to the groove openings of the grooves of the first sub-stator in such a way that the cogging torque of the sub-stators is mutually compensated or the torque ripple is reduced.

3. The stator according to claim 1 or 2, wherein the at least two sub-stators have the same design and, in particular, the same geometry except for the shifting of the groove openings .

4. The stator according to claim 1 or 2, wherein the at least two sub-stators feature between adjacent grooves pole teeth that have the same pole shape and pole width, but groove openings that are shifted relative to one another.

5. The stator according to claim 1, wherein the sub-stators are combined in the axial direction and grooves of different depths are provided.

6. The stator according to claim 1, wherein the sub-stators are combined in the circumferential direction and the stator features at least one divisible yoke.

7. An electric machine with a stator according to claim 1, and further comprising:
a rotor that is supported such that it is rotatable relative to the stator.

8. The electric machine according to claim 7, wherein the electric machine consists of one of the following types: linear motor, transverse flux motor, radial flux motor, asynchronous motor, synchronous motor.

9. The electric machine according to claim 7 or 8 realized in the form of a machine with internal rotor or in the form of a machine with external rotor.

10. The electric machine according to claim 7, wherein the rotor consists of one of the following types: a cage rotor, a multilayer rotor in the case of an asynchronous motor or a permanent magnet rotor in the case of a synchronous motor, a rotor with buried magnets, an electrically fed rotor, particularly a smooth-core rotor, a salient-pole rotor, a heteropolar rotor or a homopolar rotor.
